(19) United States
(12) Patent Application Publication
(10) Pub. No.: US 2026/0300365 A1
(43) Pub. Date: Oct. 1, 2026

(54) Enhancing Recorded Conversations

(71) Applicant: Yac Inc., Wilmington, DE (US)

(72) Inventor: Hunter McKinley, Gainesville, FL (US)

(21) Appl. No.: 19/568,565

(22) Filed: Mar. 16, 2026

Related U.S. Application Data
(63) Continuation-in-part of application No. 19/534,587, filed on Feb. 9, 2026.
Application No. 19/534,587 is a continuation-in-part of application No. 19/089,451, filed on Mar. 25, 2025, now Pat. No. 12,548,560.

(51) Int. Cl. G06F 16/34; G06Q 10/107; G06Q 30/0241; G10L 15/26; G10L 17/00

(52) U.S. Cl. CPC G06F 16/345; G06Q 10/107; G06Q 30/0241; G10L 15/26; G10L 17/00

(57) ABSTRACT

In one embodiment, a method includes determining a scheduled start time of a meeting between a user and one or more persons; and activating, based on the scheduled start time of the meeting, a microphone of an electronic device to record audio in a vicinity of the user. The method further includes triggering, based on the scheduled meeting, a conversation-extraction process for the user and the one or more persons, including: (1) generating a transcription of at least a portion of the recorded audio; and (2) determining, based on the transcription and from an AI model, a summary of the conversation. The method further includes storing the summary in a data store for the user.

### PRIORITY CLAIM

This application is a continuation-in-part of, and claims the benefit under 35 U.S.C. § 120 of, U.S. patent application Ser. No. 19/534,587 filed Feb. 9, 2026, which claims the benefit under 35 U.S.C. § 120 as a continuation-in-part of U.S. patent application Ser. No. 19/089,451 filed Mar. 25, 2025, each of which is incorporated by reference herein.

### TECHNICAL FIELD

This application generally relates to enhancing recorded conversations.

### BACKGROUND

Many business events are structured around having many conversations with a variety of people, many of whom are being introduced for the first time. For example, trade shows, conferences, expos, and the like often include many different entities (e.g., businesses) that can reserve dedicated space at the event (e.g., a booth), send attendees to the event, or both. Such events typically involve many free-flowing and unstructured conversations with many different attendees, and the conversations at such events are typically of uncertain relevance or value prior to the conversations occurring. For example, a business attendee looking to make client or vendor connections for their asphalt-making business at an equipment-manufacturing trade show may have many conversations with attendees that are not relevant to the asphalt-maker's purpose for attending. For instance, many other attendees may be in other lines of work that are not directly related to asphalt making, and some conversations may be personal in nature (e.g., catching up with old colleagues). While the exposure and connections offered by such events provide well-known benefits to businesses and attendees, the specific conversations that realize this value are typically very unpredictable.

### BRIEF DESCRIPTION OF THE DRAWINGS

FIG. 1 illustrates an example method for recording and enhancing conversations between participants.

FIG. 2 illustrates an example computing system.

### DESCRIPTION OF EXAMPLE EMBODIMENTS

At an event (such as a trade show, a conference, or an expo, etc.) an attendee and one or more other persons may engage in a conversation. An attendee at a professional event may have many interactions over the course of a relatively short period of time, and an attendee does not necessarily know in advance which conversations will be meaningful to a business relationship and which will be superficial or personal. An attendee typically realizes only after the fact that their conversation with another person was significant enough to warrant follow up, and then an exchange of some personal information typically takes place. For instance, participants to a conversation may tell each other their phone numbers, email addresses, or other contact information. As another example, participants may provide some physical identifying information, such as a business card or badge with a QR code, when an interaction in a professional environment is relevant enough to warrant such exchange. This can still apply even when meetings are scheduled, rather than being ad hoc.

However, the type of information described above is not unique to the specific interaction that just occurred, nor does the information explain why the interaction was relevant. At the end of the event, participants therefore must recall the specific details about each meaningful interaction and how it relates to the information received as a result of the meaningful interaction. For example, an attorney at a conference may meet (1) a potential client who is interested in the attorney's line of work, (2) a colleague who is interested in collaborating with the attorney on an article in an industry publication and (3) a vendor who can provide marketing services for the attorney's law firm. The purpose and content of these business interactions are very different, but in each instance, the attorney's contact information or business card, etc., is the same, and the information provided does nothing to signify the unique importance of each particular interaction. This creates challenges when following-up on meaningful interactions, as the interaction details and follow-up steps are subject to the limitations of a person's memory (which is often further strained by the relatively high number of conversations that can occur during such events), reducing the efficiency and benefits of such events. Many attendees take brief notes about an interaction, such as on a business card provided by a participant, but these notes do not capture the full conversation that the participants had and require dedicated time and effort to create.

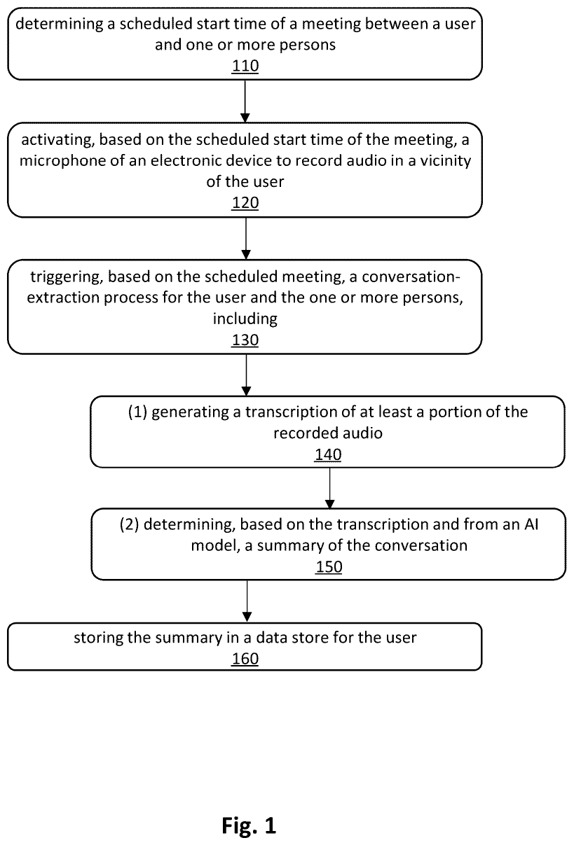

Automatically recording audio of conversations, whether continuously or based on predefined conditions, ensures that the audio is available after the fact for those instances in which a conversation was meaningful, which cannot be fully predicted in advance. FIG. 1 illustrates an example method for recording and enhancing conversations between participants. Step 110 of the example method of FIG. 1 includes determining a scheduled start time of a meeting between a user and one or more persons. A meeting may be in-person or may be electronic (e.g., using videoconferencing tools). In particular embodiments, the start and stop time of a meeting may be determined via direct input by a user, or may be determined by accessing existing data about the user's events (e.g., by integrating with a calendar application; by deducing or extracting meeting times from communications such as emails, messages, or texts, etc.; by accessing a schedule of events for the user (as well as for other users, in particular embodiments) at a trade show, etc.

In particular embodiments, the schedule meeting may be used to automatically trigger subsequent steps, such as audio recording and conversation extraction, as described below. In particular embodiments, the determined meeting endpoints may trigger audio recording and conversation extraction in conjunction with additional functionality, such as speaker activity, etc.

Step 120 of the example method FIG. 1 includes activating, based on the scheduled start time of the meeting, a microphone of an electronic device to record audio in a vicinity of the user. For instance, the electronic device may be a smartphone, a voice recorder, a smartwatch, etc. Any suitable transducer for capturing audio signals may be used as a microphone, which may be activated to record audio.

Recording may begin before the start time (e.g., a predetermined amount before, such as a few seconds or 1 or 5 minutes, etc.) and may end after the end time, or may begin and/or end at the scheduled start and stop times of the meeting. For instance, when the start time of a meeting scheduled for a user occurs, then this may trigger audio recording for that user, and the recording may end at the scheduled stop time. In particular embodiments, a recording may start at (or before) a scheduled start time of an event, such as a meeting, and then end based on one or more other inputs, such as input from a user turning off the recording, recognition of certain parting words or phrases (e.g., “goodbye”), or a period of elapsed time in which participants to a meeting are no longer speaking (e.g., based on voice recognition or semantic conversation content, etc.). In particular embodiments, a start time of an event may be a condition precedent to automatically starting a recording, but other conditions may be required as well. For example, recording may begin based on a meeting's scheduled start time and when there is speech present or when participants to a meeting have joined a virtual or real meeting room. In particular embodiments, participant identification (whether using audio or video to identify the participants) may be used to determine whether the participants to a scheduled meeting are present for the meeting at or a little before the scheduled start time, at which point recording may begin.

In particular embodiments, the audio may be recorded continuously from the time a recording starts until the time the recording ends. In particular embodiments, the recording may be permanently stored, while in other embodiments the recording may overwrite portions of itself. For instance, the recording may include a sliding window (e.g., a 20-minute window, a 40-minute window, an hour window, etc.) in which the oldest portion (e.g., the oldest 1-minute portion, etc.) is overwritten as time passes, such that the recording contains the most recent block of audio of a certain length of time.

Particular embodiments disclosed herein may include capturing, by a camera of an electronic device, an image that includes information about a person in the vicinity of the recorded audio. The electronic device in may be the same electronic device in step 110; e.g., a smartphone may have both a camera and a microphone, and therefore may be used to perform steps 110 as well as the image capture. In particular embodiment, these steps may be performed by separate devices.

The image that includes information about a person may be an image of a business card, an event badge, a QR code (e.g., to a LinkedIn profile or to another social media profile), etc. For instance, a user and a person may be having a conversation at a trade show. Attendees at such events typically have a physical item with identifying information, such as a business card or badge. When the user and the person have a meaningful conversation, then the user may take a picture of the person's business card, badge, etc.

In particular embodiments, in order to take a picture, the user may open an application (e.g., on the user's smartphone) that has a user interface with a UI element (e.g., a button) that activates the device camera to capture an image. The user interface may also include other elements, e.g., to start or stop audio recording.

In particular embodiments, capturing the image may automatically trigger subsequent steps. In other words, if a user and a person are having a conversation (which is recorded after step 120) and the user takes an image of, e.g., a business card, that one-click functionality may automatically trigger the functionality described below, including the AI functionality and/or the OCR functionality described below. For example, in particular embodiments, audio recording may be started when a camera captures an image (e.g., a meeting start time may be a necessary, but not sufficient, condition for starting an audio recording). For instance, automatically recording audio based on predefined conditions may include starting an audio recording when a camera captures an image that includes information about a person in the vicinity of the recorded audio.

In particular embodiments the captured image is processed, for example by using optical character recognition (OCR) to identify text in the image. The processing may occur client side (e.g., may be occur on a smartphone used to capture the image) or may occur remotely, e.g., by a server device, as explained more fully below.

In particular embodiments, the image may be sent to a server device (along with a portion of the recorded audio, in particular embodiments and as described below). In particular embodiments, a link may be created to a landing page that includes the recorded audio and other content described below. For instance, teams may have some members attend a trade show while other members perform follow-ups on leads generated at a trade show, and immediately creating a landing page in response to capturing the image described above may facilitate this follow-up process. In particular embodiments, a captured image may be included at the landing page.

Particular embodiments may include extracting, based at least on a captured image or from participant information from a scheduled meeting, identifying information about the person. For instance, an OCR process may be used to extract text from a captured image, which may provide information such as the person's name, company, email address, etc. Some or all of this information may be provided as part of a scheduled meeting. In particular embodiments, identifying information about a person may be extracted from the image or from the details of a scheduled meeting between the user and the person, and this information may be used to perform internet search queries that enrich the identifying information.

For instance, an AI model may be fed the text of meeting details and may identify a label for portions of the text (e.g., identifying which text corresponds to a personal name, a company name, a phone number, an email address, etc.). An internet search may then be performed using the labelled data, e.g., a search for a person whose names matches the text identified as a personal name and whose employer matches the text identified as a company name may be performed. Particular embodiments may identify information corresponding to a predetermined list of information items, such as personal name, company name, email address, phone number, LinkedIn profile, etc. This set of information may correspond to information that can be uploaded to a particular CRM (customer relationship management) software. Once the information is enriched, then this additional information may be added to the landing page described above, in particular embodiments.

Particular embodiments may include extracting a portion of the recorded audio corresponding to a conversation between a user and the person. The portion of the recorded audio is an estimate, or determination, of the portion that is the conversation between the user and the person, e.g., whose identifying information was captured as described above. In particular embodiments, a user may identify the beginning and end of the conversation, which is used to extract that portion of the audio. In other embodiments, the portion may be automatically identified. For instance, a machine-learning model may be trained to identify the beginning and end of a conversation based on, for example, speaker IDs, semantic meaning, and other features such as the presence of common greeting phrases or farewell phrases. The conversation may initially be identified as the one that is occurring e.g., based on a meeting start time or when the image is captured as described above. The speakers IDs, semantic meanings, etc. may be identified using the audio immediately near this point, and the beginning and end of the conversation may be determined by working backwards and forwards in the recorded audio using these initial identifications. In particular embodiments, the extracted audio may be based on the start or stop time of a scheduled meeting (e.g., may be within that window but more tailored, based on features described above).

Step 130 of the example method of FIG. 1. includes triggering, based on the scheduled meeting (e.g., based on a scheduled start and end time, a scheduled start time and duration, etc. as described above), a conversation-extraction process for the user and the one or more persons. The conversation-extraction process includes step 140 of the method of FIG. 1, where step 140 incudes a transcription of at least a portion of the recorded audio. For instance, a trained AI model may be used to perform natural-language transcription from a portion of audio. In particular embodiments, step 140 may be performed client side (e.g., by a smartphone that captured the audio) or may be performed server side (e.g., after uploading to the cloud). In particular embodiments, the transcription may be uploaded to the landing page described above, along with (in particular embodiments) the audio data itself.

The conversation-extraction process also includes step 150 of the example method of FIG. 1, where step 150 includes determining, based on the transcription and from an AI model, a summary of the conversation. The summary may include a description of the conversation, next steps following the conversation, and/or a summary of personal details discussed during the conversation.

For instance, the transcription and a prompt may be provided to an LLM instructing the LLM to output a summary of the transcription. In particular embodiments, token (or context) length limitations require dividing the transcription into multiple parts, and a summary may be generated for each part. For example, if a transcription is divided into four parts, then an LLM may be prompted to generate a summary of the conversation in each transcription part, and then the LLM may be prompted to generate an overall summary of the conversation from the four generated summaries. The same process may be used to generate a summary of next steps and personal details (e.g., an anecdote about a vacation or about a person's family or hobbies) discussed during the conversation.

In particular embodiments, the transcription may not perfectly capture the natural language in an audio portion. Moreover, the audio may be captured in a noisy environment with multiple speakers; e.g., a trade show may involve many booths situated in close proximity, and an audio recording may capture both a conversation between a person and a user as well as other audio. This may be exacerbated by silences in the conversation, e.g., a conversation may include a 1-2 minute demonstration, and there may be minimal or intermittent conversation during that demonstration. Thus, a prompt may instruct an LLM to account for periods of silence and for background noise when generation conversation summaries. For instance, a prompt may instruct the LLM to ignore transcribed text that is semantically unrelated to rest of the conversation (e.g., because the recording picked up a piece of a nearby conversation).

In particular embodiments, the result of step 150 may be a few bullet points for each of (1) the conversation (2) next steps (e.g., follow up discussed during the conversation) and (3) personal information discussed during the conversation.

Step 160 of the example method of FIG. 1 includes storing the summary in a data store for the user. In particular embodiments, step 160 may include storing such information in a landing page, and a link to this page may be provided to the user. In particular embodiments, step 160 may include automatically uploading such information to a CRM for the user. The information uploaded may be all or a subset of information extracted from an image (if applicable), the supplemental information, and the summaries generated from the transcribed audio portion. For instance, this information may be uploaded to each particular CRM to the extent that CRM has a dedicated field for such information. Additional information may be put in an overflow section (e.g., a notes section); and in particular embodiments, a link to the conversation-specific landing page may be uploaded to the CRM so that the full set of information (e.g., summaries, etc.) is available to the user from the contact information in the CRM database.

Particular embodiments may automatically prepare and send draft emails for the user and/or scheduling meetings with conversation participants. For instance, the conversation summaries may be used to draft an email from the user to the person. The user's calendar may be accessed, and then meeting invitations may be automatically scheduled and sent to persons along with the drafted emails. In particular embodiments, draft emails and meeting invitations may be prepared but not sent without user approval, so that a user can review the content before sending it out to actual or prospective clients.

In particular embodiments, an LLM may be asked to generate draft emails based on the various summaries generated in the example method of FIG. 1. As a result, in particular embodiments a user can go from having a scheduled meeting with a person, having a conversation with that person, and then having automatically drafted, conversation-relevant emails prepared or sent on that user's behalf. The meeting-scheduling process is the trigger for the other functionality, in particular embodiments, giving the user simple but elegant control over which conversations warrant additional follow-up (e.g., CRM generate, emails, meetings, etc.), while substantially increasing the efficiency of those processes.

In particular embodiments, information from multiple users may be aggregated to provide broader conversation metrics about the conversations at an event. For example, it is impossible for organizers of a trade show to know what conversations are occurring during the trade show and what the effect of those conversations are. However, recorded conversations from multiple users may be used to generate insights about the trade show. For example, the most frequent conversation topics, keywords, and the like can be aggregated from the recorded audio. Generating these insights may involve transcribing each recording, removing personal information (e.g., personal names, brand names, etc.) and then prompting an LLM to summarize the audio.

In particular embodiments, aggregated audio from an event (e.g., a trade show) may be used to provide insights regarding conversation value. Such insights may be based on conversation data and, in particular embodiments, on subsequent activity related to or resulting from those conversations. For example, an organizer of a trade show regarding pet products may be provided with insights such as “attendees who talked about organic products at this show made 7 times more deals than those who talked about pet toys.” These types of insights can be used to approach attendees with information both in real time (e.g., during or immediately after the event) or some time after the event.

For instance, an organizer may secure bookings for a subsequent event at a current event. The organizer may be able to explain to an exhibitor what the projected impact of the current event is, e.g., that an exhibitor has booked 4-5 million worth of potential contracts at the current event, based on the recorded conversations specific to that exhibitor, or that the exhibitor was in the top 10% of contracts opened for exhibitors, based on the overall conversations. Potential contracts may be valued based on average deal size over a particular period of time (e.g., lifetime), which may be provided by an entity or determined automatically based on access to that entity's CRM data. As another example, the exhibitor's CRM data entered as a result of the recorded and enhanced conversations may be accessed over time to determine what the subsequent impact of a particular event is (e. g,, the value of contracts that actually ended up being entered into as a result of contacts made at the event). As a result, insights are based on real data tied to actual conversations at an event, rather than merely being based on, e.g., survey data, which is notoriously unreliable.

In particular embodiments, the start and/or stop time for a recording may be determined by a trained AI module, for example based on input scheduled meeting times, etc. In particular embodiments, content may be provided during or in between meetings, based on a meeting schedule. For example, music may be played on an electronic device, such as a device used to record audio, in between meetings, as indicated based on scheduled meeting times (and, in particular embodiments, on additional factors such as the absence of spoken content over a period of time, etc.). As another example, an electronic device such as the device used to record content may display one or more advertisements in between, and/or during, scheduled meetings. For instance, these advertisements may play in an application that is running on the electronic device, and in particular embodiments, the application must be open in order to record audio and trigger subsequent AI processing. In between meetings or during meetings, display space on the electronic device may be used to present one or more advertisements, which may be auctioned off by the provider of the application, for example. In particular embodiments, the set of electronic devices used to record audio as described herein may at times (e.g., outside of scheduled meetings) be used as a public address (PA) system, for example during a trade show.

In particular embodiments, a summary of the conversation may include one or more of a semantic summary of the conversation, how much each participant talked (e.g., who talked more), how well the user set an agenda for the meeting, how well the user stayed on topic, how polite the user was, etc. In particular embodiments, these factors may be used to generate a grade for the meeting while giving practical notes and tips about the meeting for training purposes, e.g., so that a company can use the summary to identify meetings that are good candidates for training purposes and, in particular embodiments, use the summary as an explanation of why a particular meeting illustrates training teaching points. In particular embodiments, a report may be generated based on the summaries of each separate user of a particular entity at an event, such as a trade show. These reports may, for example, summarize overall (based on each user's meeting) how well each particular user stayed on topic, was polite, etc. Thus, the report may provide a per-user breakdown of how that user performed across meetings at an event, and/or identify who engaged in the best or worst meetings at the event.

In particular embodiments, summaries of conversation may be used to generate aggregate reports across an event. Such aggregate reports may not include any personally identifiable information. This report may provided to, for example, an organizer of the event (e.g., an organizer of a trade show). The report may be broken down on a per-entity basis, i.e., based on the meetings at that event for that entity. In particular embodiments, a report may identify the outcomes of an entity, such as a specific company, at that event. For example, a report may summarize, from the summaries of each recorded conversation of a particular company's meetings, that a particular company had 3 no-show meetings, but also had 17 next steps already booked with meeting participants, and 3 next steps (e.g., emails, follow-up meetings scheduled, etc.) that have already begun. This report may be used, for example, to identify how that company should book and/or schedule for the next event.

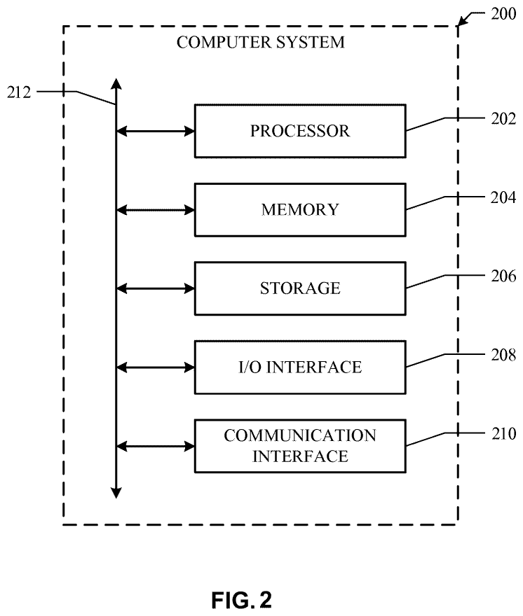

FIG. 2 illustrates an example computer system 200. In particular embodiments, one or more computer systems 200 perform one or more steps of one or more methods described or illustrated herein. In particular embodiments, one or more computer systems 200 provide functionality described or illustrated herein. In particular embodiments, software running on one or more computer systems 200 performs one or more steps of one or more methods described or illustrated herein or provides functionality described or illustrated herein. Particular embodiments include one or more portions of one or more computer systems 200. Herein, reference to a computer system may encompass a computing device, and vice versa, where appropriate. Moreover, reference to a computer system may encompass one or more computer systems, where appropriate.

This disclosure contemplates any suitable number of computer systems 200. This disclosure contemplates computer system 200 taking any suitable physical form. As example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 200 may include one or more computer systems 200; be unitary or distributed; span multiple locations; span multiple machines; span multiple data centers; or reside in a cloud, which may include one or more cloud components in one or more networks. Where appropriate, one or more computer systems 200 may perform without substantial spatial or temporal limitation one or more steps of one or more methods described or illustrated herein. As an example and not by way of limitation, one or more computer systems 200 may perform in real time or in batch mode one or more steps of one or more methods described or illustrated herein. One or more computer systems 200 may perform at different times or at different locations one or more steps of one or more methods described or illustrated herein, where appropriate.

In particular embodiments, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In particular embodiments, processor 202 includes hardware for executing instructions, such as those making up a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. In particular embodiments, processor 202 may include one or more internal caches for data, instructions, or addresses. This disclosure contemplates processor 202 including any suitable number of any suitable internal caches, where appropriate. As an example and not by way of limitation, processor 202 may include one or more instruction caches, one or more data caches, and one or more translation lookaside buffers (TLBs). Instructions in the instruction caches may be copies of instructions in memory 204 or storage 206, and the instruction caches may speed up retrieval of those instructions by processor 202. Data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data. The data caches may speed up read or write operations by processor 202. The TLBs may speed up virtual-address translation for processor 202. In particular embodiments, processor 202 may include one or more internal registers for data, instructions, or addresses. This disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In particular embodiments, memory 204 includes main memory for storing instructions for processor 202 to execute or data for processor 202 to operate on. As an example and not by way of limitation, computer system 200 may load instructions from storage 206 or another source (such as, for example, another computer system 200) to memory 204. Processor 202 may then load the instructions from memory 204 to an internal register or internal cache. To execute the instructions, processor 202 may retrieve the instructions from the internal register or internal cache and decode them. During or after execution of the instructions, processor 202 may write one or more results (which may be intermediate or final results) to the internal register or internal cache. Processor 202 may then write one or more of those results to memory 204. In particular embodiments, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere). One or more memory buses (which may each include an address bus and a data bus) may couple processor 202 to memory 204. Bus 212 may include one or more memory buses, as described below. In particular embodiments, one or more memory management units (MMUs) reside between processor 202 and memory 204 and facilitate accesses to memory 204 requested by processor 202. In particular embodiments, memory 204 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 204 may include one or more memories 204, where appropriate. Although this disclosure describes and illustrates particular memory, this disclosure contemplates any suitable memory.

In particular embodiments, storage 206 includes mass storage for data or instructions. As an example and not by way of limitation, storage 206 may include a hard disk drive (HDD), a floppy disk drive, flash memory, an optical disc, a magneto-optical disc, magnetic tape, or a Universal Serial Bus (USB) drive or a combination of two or more of these. Storage 206 may include removable or non-removable (or fixed) media, where appropriate. Storage 206 may be internal or external to computer system 200, where appropriate. In particular embodiments, storage 206 is non-volatile, solid-state memory. In particular embodiments, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form. Storage 206 may include one or more storage control units facilitating communication between processor 202 and storage 206, where appropriate. Where appropriate, storage 206 may include one or more storages 206. Although this disclosure describes and illustrates particular storage, this disclosure contemplates any suitable storage.

In particular embodiments, I/O interface 208 includes hardware, software, or both, providing one or more interfaces for communication between computer system 200 and one or more I/O devices. Computer system 200 may include one or more of these I/O devices, where appropriate. One or more of these I/O devices may enable communication between a person and computer system 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 208 for them. Where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In particular embodiments, communication interface 210 includes hardware, software, or both providing one or more interfaces for communication (such as, for example, packet-based communication) between computer system 200 and one or more other computer systems 200 or one or more networks. As an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it. As an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 200 may include any suitable communication interface 210 for any of these networks, where appropriate. Communication interface 210 may include one or more communication interfaces 210, where appropriate. Although this disclosure describes and illustrates a particular communication interface, this disclosure contemplates any suitable communication interface.

In particular embodiments, bus 212 includes hardware, software, or both coupling components of computer system 200 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 212 may include one or more buses 212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
determining a scheduled start time of a meeting between a user and one or more persons;
activating, based on the scheduled start time of the meeting, a microphone of an electronic device to record audio in a vicinity of the user;
triggering, based on the scheduled meeting, a conversation-extraction process for the user and the one or more persons, comprising:
generating a transcription of at least a portion of the recorded audio; and
determining, based on the transcription and from an AI model, a summary of the conversation; and
storing the summary in a data store for the user.

2. The method of claim 1, further comprising extracting the at least a portion of the recorded audio corresponding to a conversation between a user and the person.

3. The method of claim 2, wherein extracting the at least a portion of the recorded audio corresponding to a conversation between a user and the person comprises determining, by an AI model, the portion of the recorded audio corresponding to the conversation.

4. The method of claim 1, further comprising:
determining a scheduled end time of the meeting; and
deactivating, based on the scheduled end time of the meeting, the microphone of the electronic device.

5. The method of claim 1, further comprising providing, outside of a time for the meeting and based at least in part on the scheduled start time, audio or visual content by the electronic device.

6. The method of claim 5, wherein the content comprises an advertisement.

7. The method of claim 1, further comprising generating, by an AI model, a draft email to the person from the user based on the summary of the conversation.

8. The method of claim 1, further comprising:
generating a transcription of each of a plurality of audio recordings from a plurality of electronic devices at a particular event;
determining, based on the generated transcriptions, one or more conversation metrics at the event.

9. The method of claim 8, wherein:
the plurality of audio recordings each correspond to one of a plurality of meetings for a particular entity at the event; and
the one or more conversation metrics comprise a summary of the outcome of the plurality of meetings for that particular entity at that particular event.

10. The method of claim 1, further comprising one or more of:
activating, based on the scheduled start time of the meeting and on an identification of one or more speakers near the scheduled start time, a microphone of an electronic device to record audio in a vicinity of the user; or
identifying the at least a portion of the audio based on an identification of one or more speakers within a duration substantially defined by the scheduled start time and a scheduled end time for the meeting.

11. A system comprising one or more non-transitory computer readable storage media storing instructions; and one or more processors operable to execute the instructions to:
determine a scheduled start time of a meeting between a user and one or more persons;
activate, based on the scheduled start time of the meeting, a microphone of an electronic device to record audio in a vicinity of the user;
trigger, based on the scheduled meeting, a conversation-extraction process for the user and the one or more persons, comprising:
generating a transcription of at least a portion of the recorded audio; and
determining, based on the transcription and from an AI model, a summary of the conversation; and
store the summary in a data store for the user.

12. The system of claim 11, further comprising one or more processors that are operable to execute the instructions to extract the at least a portion of the recorded audio corresponding to a conversation between a user and the person.

13. The system of claim 12, wherein extracting the at least a portion of the recorded audio corresponding to a conversation between a user and the person comprises determining, by an AI model, the portion of the recorded audio corresponding to the conversation.

14. The system of claim 11, further comprising one or more processors that are operable to execute the instructions to:
determine a scheduled end time of the meeting; and
deactivate, based on the scheduled end time of the meeting, the microphone of the electronic device.

15. The system of claim 11, further comprising one or more processors that are operable to execute the instructions to provide, outside of a time for the meeting and based at least in part on the scheduled start time, audio or visual content by the electronic device.

16. The system of claim 15, wherein the content comprises an advertisement.

17. The system of claim 11, further comprising one or more processors that are operable to execute the instructions to generate by an AI model, a draft email to the person from the user based on the summary of the conversation.

18. The system of claim 11, further comprising one or more processors that are operable to execute the instructions to:
generate a transcription of each of a plurality of audio recordings from a plurality of electronic devices at a particular event;
determine, based on the generated transcriptions, one or more conversation metrics at the event.

19. The system of claim 18, wherein:
the plurality of audio recordings each correspond to one of a plurality of meetings for a particular entity at the event; and
the one or more conversation metrics comprise a summary of the outcome of the plurality of meetings for that particular entity at that particular event.

20. One or more non-transitory computer readable storage media storing instructions that are operable when executed to:
determine a scheduled start time of a meeting between a user and one or more persons;
activate, based on the scheduled start time of the meeting, a microphone of an electronic device to record audio in a vicinity of the user;
trigger, based on the scheduled meeting, a conversation-extraction process for the user and the one or more persons, comprising:
generating a transcription of at least a portion of the recorded audio; and
determining, based on the transcription and from an AI model, a summary of the conversation; and
store the summary in a data store for the user.
